(19) United States
(12) Patent Application Publication
(10) Pub. No.: US 2014/0297375 A1
(43) Pub. Date: Oct. 2, 2014

(54) Facilitating Commercial Transactions

(71) Applicant: ESI-Exchange Solutions, Inc., Lincoln, MA (US)

(72) Inventors: Lawrence Richardson, Caledon East (CA); Paul Peios, Woodbridge (CA)

(21) Appl. No.: 13/852,692

(22) Filed: Mar. 28, 2013

(51) Int. Cl. G06Q 30/02

(52) U.S. Cl. CPC G06Q 30/0207; G06Q 40/04
USPC 705/14.1

(57) ABSTRACT

Among other things, a computer-implemented method includes enabling, by an electronic pricing facility, purchases of a commodity at a protected price that represents a discount from a current price of the commodity that increases as the current price rises above a middle range of the current price.

### BACKGROUND

This description relates to facilitating commercial transactions.

A commercial transaction may involve an exchange of money for goods and services. Money can be currency that represents value, is typically issued by a government, and is accepted by the public as a medium of payment. Money can also be scrip that also represents value but is accepted only by a particular organization or organizations as a medium of payment.

In some examples, a commercial transaction can include an element of price protection. For example, U.S. Pat. Nos. 7,945,500, 8,065,218 8,086,517, 8,156,022, and 8,160,952 describe various forms of price protection.

### SUMMARY

The techniques that we describe here may encompass one or more of the following (and other) aspects, features, and implementations, and combinations of them.

In one aspect, in general, a computer-implemented method includes enabling, by an electronic pricing facility, purchases of a commodity at a protected price that represents a discount from a current price of the commodity that increases as the current price rises above a middle range of the current price.

Implementations of this aspect may include one or more of the following features. The discount from the current price of the commodity decreases as the current price drops below the middle range of the current price. The protected price comprises a static promotional price that applies in the middle range of the current price. The middle range comprises a static upper current price. The middle range comprises a static lower current price. The protected price comprises a maximum amount of discount from the current price of the commodity. The commodity is available for purchase at the protected price from only a single supplier. The commodity is available for purchase at the protected price from multiple suppliers. The discount represented by the protected price is defined in a promotion of a commercial entity. At least part of the discount is paid by an entity other than the electronic pricing facility. Each of the purchases comprises a protected price determined based on a promotional price and a ceiling discount value representing a maximum discount from the current price of the commodity, in which the protected price is less than the current price of the commodity. The purchase comprises a floor discount value representing a minimum discount from the current price of the commodity. The difference between the protected price and the current price is paid in advance, by an entity other than the electronic pricing facility, based on the ceiling discount value. Any amount of the difference that remains after the purchases is not refunded to the entity. Each of the purchases is enabled depending on an expiration date associated with the discount. Each of the purchases is enabled depending on a remaining quantity of the commodity, the remaining quantity associated with the discount. The method includes receiving an advance payment of the discount. At least a portion of the advance payment of the discount is invested according to a hedging strategy.

In another aspect, in general, a computer-implemented method includes receiving first data representing a transaction for a quantity of a commodity, receiving second data associated with a person associated with the transaction, the second data representing a promotional price and a ceiling discount value representing a maximum discount from a current price of the commodity, calculating a protected price based on the promotional price and the ceiling discount value, in which the protected price is equal to the promotional price for a first range of the current price of the commodity, and equal to the current price of the commodity minus the ceiling discount value for a second range of the current price of the commodity, transmitting data authorizing the transaction at the protected price, and updating the second data based on the data describing the transaction.

In a further aspect, in general, a method includes enabling, at a fuel station, a purchase of a quantity of fuel, the purchase comprising a discount from a current retail price of fuel, the discount determined based on a promotional price and a ceiling discount value representing a maximum discount from the current retail price.

These and other aspects, features, and implementations, and combinations of them, may be expressed as apparatus, methods, methods of doing business, means or steps for performing functions, components, systems, program products, and in other ways.

Other aspects, features, and advantages will be apparent from the description and the claims.

### DESCRIPTION

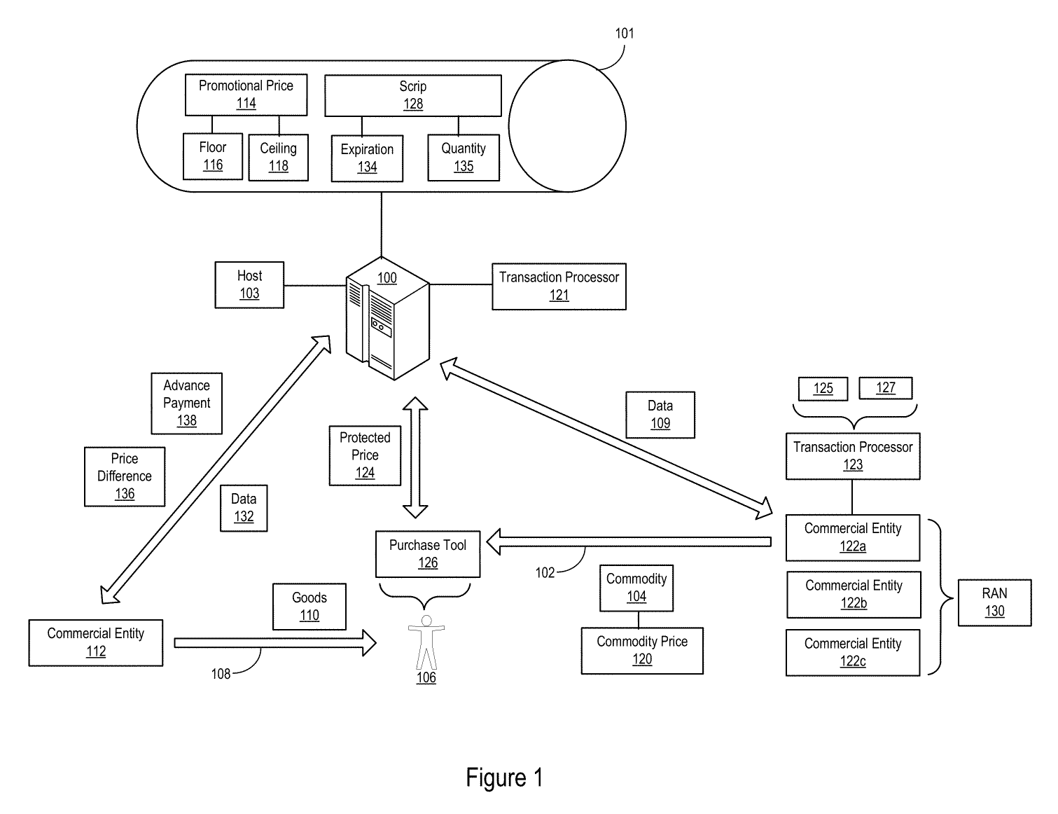

FIG. 1 shows a block diagram.

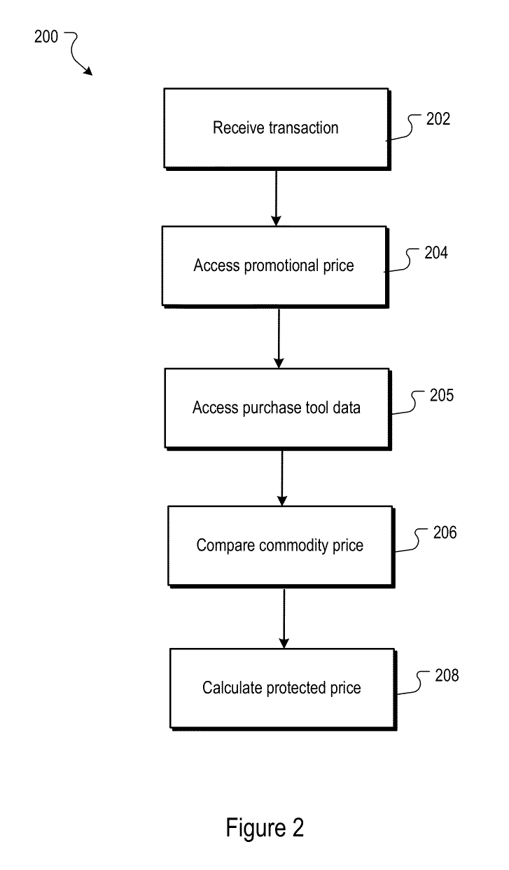

FIG. 2 shows a flowchart.

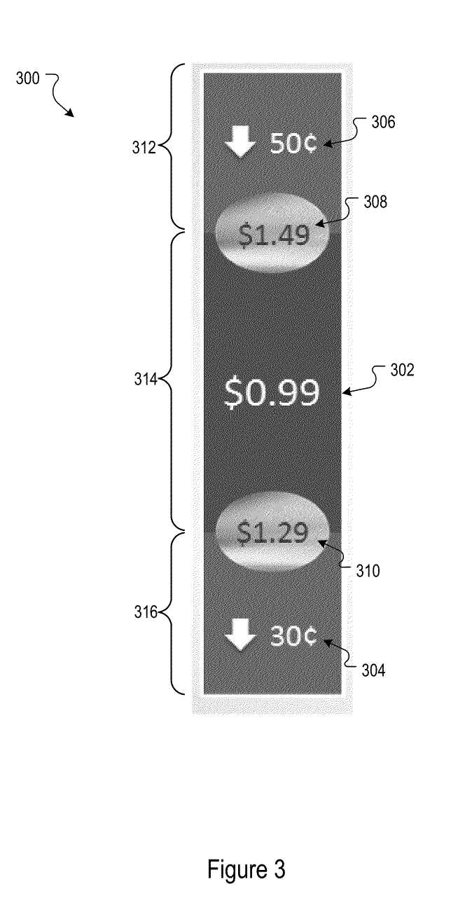

FIG. 3 shows a range of prices.

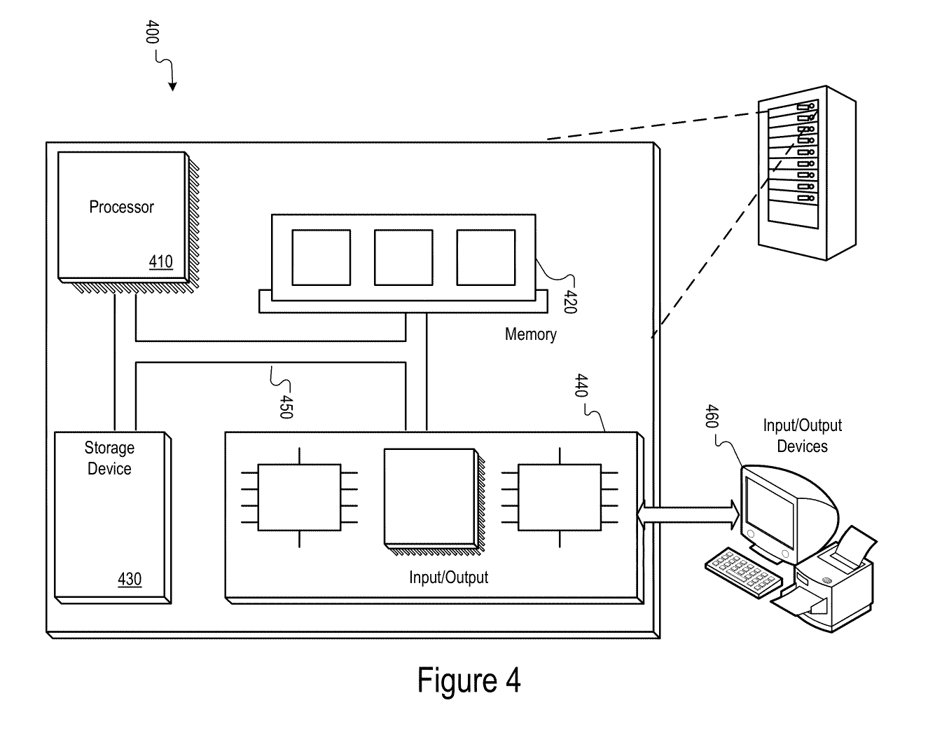

FIG. 4 shows a computer system.

A commercial entity sometimes offers its customers a promotional price for a commodity that is guaranteed for a period of time even though the normal price (without the benefit of the promotion) will vary during the period when the promotion is offered.

If the promotional price is a price that does not change for the life of the promotion, a consumer accepting the promotion may lose some of the benefit of the promotion if the commodity's normal price falls during the promotional period, and all of the benefit if the commodity's normal price falls below the promotional price. If the consumer loses the benefit of the promotion, a negative impression can be created with respect to the image of the commercial entity, which is the opposite of the intention behind the promotion. In addition, the commercial entity offering such a promotion risks reduced profit or even losses if the commodity's normal price rises during the promotional period.

In contrast, if the promotional price is arranged to rise (as the commodity's normal price rises) but not higher than a maximum price that is tied to a static ceiling value, then reduced profits or losses of the commercial entity are mitigated in some scenarios. If the price is allowed to drop (as the commodity's normal price drops) but not lower than a minimum price that is tied to a static floor value, then the consumer continues to benefit in some scenarios in which the commodity price falls. An electronic pricing facility can process transactions involving the commodity (e.g., fuels such as gasoline) to manage the floor and ceiling values tied to promotional price and maximum quantity of the commodity.

As a real-world example, a consumer buys a car from an auto manufacturer. The consumer is motivated to buy the car partly by a promotional offer that assures price protection for the consumer when he buys gasoline from a gasoline company. The promotional offer is implemented by an electronic pricing facility for the benefit of all three parties, the consumer, the gasoline company, and the auto manufacturer. The electronic pricing facility can be operated by a fourth party host which collects money from the auto manufacturer to pay for at least part of the cost of the promotion, collects money from the consumer at the rate of the promotional price when the consumer buys gasoline, pays the money collected from the consumer to the gasoline company, pays some of the money from the auto manufacturer to the gasoline company, and may keep some of the money that is handled in the transactions as compensation for hosting the facility.

In some implementations, the host of the facility also arranges for the gasoline company to support an optional discount on fuel sold to consumers under the offer (e.g., paid for by the sponsor of the associated promotion). The electronic pricing facility also manages the issuance of cards that represent the offer, the flow of information among the parties, and the flow of the funds to implement the offer.

FIG. 1 shows an example of an electronic pricing facility 100 that manages the prices and executions of transactions 102 involving a commodity 104 (e.g., gasoline). We use the term commodity in a very broad sense to include, among others, any product or service that has a price that fluctuates, including, for example, consumer products or services that are bought frequently and at prices per unit that are a relatively small part of a consumer's budget, such as gasoline. Frequently, the commodity is characterized by being sold by many competing vendors and its characteristics are largely indistinguishable as among the vendors so that they compete on the basis of the price. Further, the electronic pricing facility 100 may be associated with a host 103. The host 103 manages the electronic pricing facility 100, for example, and determines which commodities 104 are supported by the electronic pricing facility 100. In some examples, the host 103 can be an entity such as a business that operates the electronic pricing facility 100.

In this example, a person 106 has made a purchase 108 of goods 110 (or services) from a commercial entity 112 (e.g., an automobile manufacturer, grocery store, or any other provider of goods or services or both). In some cases, the goods that are bought from a commercial entity have a relationship to the commodity, for example, an automobile that uses gasoline so that, from a marketing point of view, there is a connection between the goods and the commodity in the mind of the consumer. In a transactional arrangement illustrated by FIG. 1, the purchase 108 has entitled the person 106 to be able to buy the commodity at a promotional price 114. For example, the commercial entity 112 may have offered a promotion to the person 106 of which the promotional price 114 is a component (e.g., a promotion offering the promotional price as an incentive to buy the goods).

The promotional price paid by the consumer bears a relationship to the expected typical current price of the commodity that represents a price break or a discount to the consumer. In the example of FIG. 1, the promotional price is a static price (e.g., a price that does not change) as long as the current price of the commodity is within a range between a certain upper commodity price and, in some examples, a certain lower commodity price. Within that range, the promotional price represents a range from some maximum discount per unit of the commodity to some minimum discount per unit of the commodity. If the current price of the commodity at the time the consumer buys the commodity is higher than the upper commodity price or lower than the lower commodity price, the discount enjoyed by the consumer is not a static promotional price, but rather a static maximum discount amount or a static minimum discount amount. In some examples, only a maximum discount is used, and so consumers buying a commodity that has fallen in price may get no discount.

Therefore, the promotional price 114 is associated with a ceiling discount value 118. The ceiling discount value 118 is the maximum discount a person 106 will receive on a purchase. In some implementations, the promotional price 114 is associated with a floor discount value 116. The floor discount value 116 is the minimum discount a person 106 will receive on a purchase. In some examples, the floor discount value 116 may not be used, or the floor discount value 116 could be zero.

When the person 106 engages in a transaction 102 involving the commodity 104, the person 106 is offered a commodity price 120 offered to any other retail customer. For example, the commodity price 120 can be a current retail price of the commodity 104 offered by a commercial entity 122a (e.g., a price per gallon posted by a gasoline company) offering the commodity 104. If the person 106 chooses to purchase the commodity 104, the person 106 does not pay the posted current commodity price, but instead pays a protected price 124 that can be a function of some combination of the current commodity price 120, the upper commodity price, the lower commodity price, the floor discount value 116, and the ceiling discount value 118. For example, a database 101 associated with the electronic pricing facility 100 may store information about the promotional price 114, the current commodity price, the floor discount value 116, the ceiling discount value 118, the upper commodity price (based on the ceiling discount value), and the lower commodity price (based on the floor discount value), including associating these with a particular commodity 104. The protected price can be thought of as a static promotional price for some range of a current commodity price and a varying promotional price that corresponds to a static amount of discount for other ranges of a current commodity price.

The protected price 124 for a given transaction (e.g., transaction 102) is determined by the electronic pricing facility 100 (for example, at the time of the transaction) and the transaction 102 for the purchase of the commodity 104 is facilitated and managed by the electronic pricing facility 100. For example, data 109 describing the transaction 102 (for example, the current commodity price, the date and time, the location, the number of units, and other information) can be provided to the electronic pricing facility 100 so that the electronic pricing facility 100 can calculate the protected price 124 and manage the transaction. In some implementations, the electronic pricing facility 100 may have at transaction processor 121 that processes the data 109 describing transactions 102. For example, the transaction processor 121 can receive data 109 from the commercial entity 122a and take action in response to the data 109, for example, update data stored in the database 101 and respond to the commercial entity 122a to authorize a transaction 102. In some implementations, the transaction processor 121 can determine if a transaction 102 is authorized based on the contents of the database 101. The transaction processor 121 may include one or more computer systems, e.g., a server or multiple servers in communication with a network.

In some implementations, the electronic pricing facility 100 is associated with a purchase tool 126 that the person 106 uses in connection with purchasing the commodity 104. In some examples, the purchase tool 126 can be a card that is specially configured so that it enables the person 106 to purchase the commodity 104 at the protected price 124 through the medium of the electronic pricing facility 100. Some examples of cards are credit cards, debit cards, stored value cards, prepaid cards, and gift cards. A card may have a magnetic strip, bar code, or electronic tag that identifies the card. In some examples, the purchase tool 126 could be a mobile application, e.g., an application that runs on a mobile device such as a smartphone and communicates with the commercial entity 122a to enable the protected price 124. In some examples, the purchase tool 126 can be a short-range wireless device (e.g., RFID device) that communicates with the commercial entity 122 to enable the protected price 124. The purchase tool 126 can also take other forms or combinations of them. The configuration of the purchase tool or the issuance of the purchase tool can be managed by the host 103 of the electronic pricing facility 100 on behalf of the commercial entity 122a. In this way, the commercial entity 122a need not manage any infrastructure to support the use of the protected price 124.

In some implementations, the commercial entity 122a is associated with one or more transaction processors 123 that enable the commercial entity 122a to process transactions for the commodity 104, e.g., transactions 102. For example, the transaction processor 123 could include one or more front-end modules 125 at a retail site. The front-end module 125 may include functionality for interacting with the person 106, including, for example, reading data from the purchase tool 126, accepting payment from the person 106, etc. The front-end module 125 of the transaction processor 123 could include a card reader, RFID scanner, input/output user interface, or other functionality for interacting with the person 106, the purchase tool 126, and/or other items such as credit cards. The transaction processor 123 can also include a back-end module 127. The back-end module 127 may receive data from the front-end module 125 and process the received data. For example, the back-end module 127 may interface with a computer network to send the data 109 to the electronic pricing facility 100. The back-end module 127 may include one or more computer systems, e.g., a server or servers.

In some implementations, the purchase tool 126 can be used with a single commercial entity 122a. For example, a single gasoline company may accept transactions involving the purchase tool 126. This arrangement is sometimes referred to as a “closed loop.” For example, the purchase tool could be a gift card issued by a gasoline company and accepted only by service stations associated with the gasoline company, e.g., branded with the gasoline company name or a franchisee of the gasoline company.

In some implementations, the purchase tool 126 can be used with multiple commercial entities 122a-c. For example, multiple gasoline companies may accept transactions involving the purchase tool 126. This arrangement is sometimes referred to as an “open loop.” In some cases, the purchase tool could be a credit card, such as a MasterCard, that is accepted by virtually any brand of gasoline company. An open loop is sometimes facilitated by a Restricted Authorization Network (RAN) 130. A restricted authorization network 130 is, for example, an agreement among commercial entities 122a-c to accept the same purchase tool 126.

In some examples, the purchase tool 126 represents or is otherwise associated with a quantity of scrip 128. The quantity of scrip 128 corresponds to an amount of currency and can be used to purchase the commodity 104 in the same way that current would. In some examples, the quantity of scrip 128 may be denominated in the same form as currency (e.g., one dollar of scrip may correspond to one dollar of currency). In some examples, the quantity of scrip 128 may be denominated in a different form than currency (e.g., one point of scrip may correspond to one dollar of currency, or two dollars of currency, or any other amount of currency). In some examples, the denomination of scrip is static (e.g., one point of scrip always corresponds to one dollar of currency). In some examples, the denomination of scrip is dynamic (e.g., one point of scrip may correspond to one dollar of currency at one time, and two dollars or another amount at a different time).

In some implementations, scrip does not correspond to currency, but rather corresponds to another quantity. For example, the quantity of scrip 128 can correspond to points that can be redeemed during a transaction 102. In the example of a gasoline purchase, a point could be redeemed to purchase a quantity of gasoline at the discount enabled by the protected price 124. In some examples, if scrip does not correspond to currency, a payment method that operates in tandem with the purchase tool 126 may be used. For example, the person 106 may use the purchase tool 126 to access a discount for 5 litres of gasoline (decrementing the quantity of scrip 128), and then the person 106 may use a credit card or other conventional payment method to pay for the gasoline.

The term “gift card” (or “prepaid card”) is sometimes used to describe a purchase tool 126 associated with a quantity of scrip, whether or not the scrip corresponds to currency. In contrast, the term “credit card” is sometimes used to describe a purchase tool not associated with a quantity of scrip and instead may be associated with a line of credit (e.g., credit for an amount of scrip or an amount of currency).

In some implementations, the person 106 can purchase scrip from the commercial entity 112 to use with one of the other commercial entities 122a-c. In some implementations, the person 106 receives scrip in connection with the purchase of goods 110 from the commercial entity 112. For example, the scrip can be provided to the person 106 by the commercial entity 112 as a promotional award in connection with the person's purchase of the goods 110.

In some implementations, the electronic pricing facility 100 determines the quantity of scrip 128 to be associated with the purchase tool 126. For example, the commercial entity 112 can provide data 132 to the electronic pricing facility 100, and the electronic pricing facility 100 can update the quantity of scrip 128 associated with the purchase tool 126. The process of updating the quantity of scrip 128 associated with the purchase tool 126 is sometimes referred to as “loading” or “reloading.”

In some implementations, scrip is associated with an expiration date 134. For example, when scrip is associated with the purchase tool 126 (sometimes called loading scrip onto the purchase tool) the scrip can be associated with an expiration date 134, e.g., two weeks from the time at which the scrip was loaded. When the expiration date 134 occurs, the amount of scrip loaded at that time can be deducted from the quantity of scrip 128.

In some implementations, scrip is associated with a remaining quantity 135 of the associated commodity 104. For example, when scrip is associated with the purchase tool 126 the scrip can be associated with a remaining quantity 135, e.g., 50 litres of gasoline. The remaining quantity 135 can be decremented as the person 106 purchases a quantity of the commodity 104 (e.g., using the purchase tool 126). When the remaining quantity 135 is depleted by the person 106, scrip can no longer be used to purchase the commodity 104. In some implementations, the remaining quantity 135 is associated with the particular purchase tool 126 associated with the scrip 128. As a real-world example, the purchase tool 126 may be authorized (e.g., by the host 103) to be used in connection with the purchase a total of 10 litres of gasoline over the life of the purchase tool 126. Even if the quantity of scrip 128 is sufficient to purchase more than 10 liters of gasoline over the course of the person's use of the purchase tool 126, the remaining quantity 135 may, if depleted, may bar the use of the quantity of scrip 128. For example, the transaction processor 121 of the electronic pricing facility 100 may decline a transaction 102 in which the purchase tool 126 is used.

In some implementations, when the remaining quantity 135 is used, a ceiling price 118 need not be used. For example, the promotional price 114 can be used for all transactions 102 enabled by the purchase tool 126, and the remaining quantity 135 can limit the amount of the commodity 104 that can be purchased using the purchase tool 126. Once the remaining quantity 135 of the commodity 104 is purchased at promotional price 114, the purchase tool 126 cannot be used to purchase any more of the commodity 104.

As an example, a gift card can be loaded with a quantity of scrip 128 that corresponds to $500, and a remaining quantity 135 of 500 litres of gasoline. The gift card can also be associated with a promotional price 114 of $1/litre. In this example, the quantity of scrip 128 is depleted based on the current retail price of gasoline, rather than the promotional price. When the person 106 buys gasoline, the person is charged $1 regardless of a current retail price of gasoline. However, the quantity of scrip 128 is depleted based on the current retail price of gasoline. For example, if the current retail price of gasoline is $2, and the person buys 10 litres of gasoline, then the person is charged $10, but the quantity of scrip is depleted by $20. If the current retail price of gasoline rises, the quantity of scrip will be depleted more quickly, limiting the amount of gasoline that the person can buy at the promotional price. The amount of gasoline that the person can buy at the promotional price is also limited by the remaining quantity associated with the card.

When the person 106 buys the commodity 104, the person 106 pays a protected price 124 that may be lower than the commodity price 120. The difference 136 (e.g., the discount) between the commodity price 120 and the protected price 124 may be paid by another party to the commercial entity 122a that sold the commodity 104 so that the commercial entity 122a receives the full commodity price 120. In some examples, the difference 136 may be paid by the electronic pricing facility 100 (e.g., at the time the commodity 104 is purchased) and charged to the commercial entity 112 (so that the commercial entity 112 is responsible for the costs of the promotion). For example, the host 103 of the electronic pricing facility 100 can have an agreement with the commercial entity 112 to pay the price difference 136 in this way.

In some examples, an advance payment 138 on account of the discounts 136 that are expected to be incurred for transactions in the future is paid by the commercial entity 112 before the purchase by the persons of the commodity. The electronic pricing facility 100 can authorize transactions involving the purchase tool 126 for an amount of discounts on a commodity 104 that are covered by the advance payment 138. For example, the advance payment 138 can be based on the ceiling discount value 118 associated with a promotional price 114. Since the ceiling discount value 118 represents the maximum discount a person 106 will receive for the purchase of a commodity 104, the advance payment 138 can be calculated as a quantity of a commodity 104 sales of which are to be covered multiplied by the ceiling discount value 118. For example, if the commodity is gasoline priced per litre, and the ceiling discount value 118 is 50 cents, then an advance payment 138 of $500 would authorize purchases of up to one thousand litres of gasoline at a protected price 124 or more depending on the current commodity prices for actual transactions with purchasers. In some implementations, the electronic pricing facility 100 may authorize purchases beyond those covered by an advance payment 138.

In some implementations, if the full amount of the advance payment 138 is not used (e.g., some or all purchases of the commodity 104 are made at a protected price 124 that is less than the sum of the promotional price 114 and the ceiling discount value 116), then the electronic pricing facility 100 may refund the balance of the advance payment 138 to the commercial entity 112. In some implementations, the balance of the advance payment 138 is not refunded or not fully refunded. In some examples, the advance payment 138 can be based on a quantity of the commodity 104 (e.g., 1000 litres of gasoline) multiplied by the ceiling discount value 118 (maximum benefit to the end consumer).

In some implementations, other techniques can be used by the electronic pricing facility 100 to enable the protected price 124. In some examples, hedging techniques can be used. For example, the host 103 can invest a portion of the advance payment 138 in commodities futures contracts. If the price of the commodity 104 rises, then the host 103 may offset the higher cost of the commodity 104 (e.g., the higher cost beyond the promotional price 114) by proceeds from the sale of the appreciated futures contracts. If the price of the commodity 104 falls, then some or all of the advance payment 138 may be profit to the host 103, because the difference between the protected price 124 and the promotional price 114 may be lower than the advance payment 138. However, the profit is offset by the net loss from the sale of the depreciated futures contracts. In some examples, funds invested in futures contracts come from a source other than the advance payment 138. For example, the funds could come from a different payment from the commercial entity 112, or the funds could come from the host 103, or the funds could come from the person 106, or the funds could come from another source. If hedging is used, the floor price 116 need not be used, and if hedging is used, the ceiling price 118 need not be used. In some examples, a hedging strategy is used with a closed loop system.

FIG. 2 shows an example process 200 for determining a protected price for a given transaction. The process 200 is described with respect to the protected price 124 shown in FIG. 1. For example, the process 200 can be carried out by the electronic pricing facility 100 at the time of the transaction.

Data describing a transaction is received 202. The data may include, but not limited to an identification of a person 106, a commodity 104, a commodity price 120, a quantity of the commodity purchased (e.g., number of litres of gasoline), date and time of the transaction, identity of the commercial entity 122a-c, and any other data relevant to a transaction 102.

Data describing a promotional price is accessed 204. For example, the promotional price 114 may be associated with the commodity 104 and also associated with the person 106, e.g., a promotional price 114 offered to the person 106 as part of a promotion offered by a commercial entity 112. The data about the promotional price 114 can include a floor discount value 116 and a ceiling discount value 118.

Data associated with the purchase tool 126 is accessed 205. The data associated with the purchase tool 126 may include an amount of scrip 128, and expiration date 134 associated with the scrip, and a remaining quantity 135 of the commodity 104. In some examples, if the amount of scrip 128 or the remaining quantity 135 is zero then the electronic pricing facility 100 may decline the transaction. In some examples, if the expiration date 134 indicates that the scrip or the purchase tool has expired then the electronic pricing facility 100 may decline the transaction.

The commodity price is compared 206 to the sum of the promotional price and the floor discount value, and the sum of the promotional price and the ceiling discount value.

Based on the comparison, the protected price is calculated 208.

If the commodity price 120 is greater than the sum of the promotional price 114 and the floor discount value 116, and less than the sum of the promotional price and the ceiling discount value 118, then the protected price 124 is equal to the promotional price 114.

If the commodity price 120 is greater than the sum of the promotional price 114 and the ceiling discount value 118, the protected price 124 is calculated 208 to be commodity price minus the ceiling discount value 118.

If the commodity price 120 is less than the sum of the promotional price 114 and the floor discount value 116, the protected price 124 is calculated 208 to be commodity price minus the floor discount value 118.

In this way, the person 106 receives a discount on the commodity price 120 in all scenarios, but the discount can be adjusted as the commodity price 120 fluctuates.

Referring to FIG. 3, the purchase tool could be a gasoline card offered as a promotional item by a commercial entity that a consumer uses to buy gasoline. A protected price 300 enabled by the gasoline card (e.g., enabled by the use of the gasoline card at a gasoline station that interacts with an electronic pricing facility 100) can vary based on the retail price of gasoline. In some examples, the card could function as a gift card that is loaded with scrip, or the card could be used in association with a payment card (e.g., a credit card or debit card). The card can be associated with a promotional price 302 of $0.99 per litre, a floor discount value 304 of $0.30 per litre, and a ceiling discount value 306 of $0.50 per litre (and thus, based on the discount values, a upper current price 308 of $1.49 and a lower current price 310 of $1.29). Prices in a range 312 above $1.49 per litre will result in a savings to the consumer of $0.50 per litre. Prices in a range 314 from $1.29 to $1.49 per litre will result in a price of $0.99 per litre to the consumer. Gasoline prices in a range 316 below $1.29 per litre will result in a savings of $0.30 per litre. In this way, the commercial entity is protected when financially supporting the promotion should an unexpected spike in gasoline prices occur. Further, the person will receive a discount is prices fall to near, at, or below the promotional price.

In some examples, the protected price 300 is enabled for some grades of gasoline but not others. For example, the protected price 300 may be enabled for a regular grade of gasoline, and not enabled for a premium grade of gasoline. In this way, a consumer would pay the protected price 300 for the regular grade, and a conventional retail price for the premium grade (or vice-versa, depending on the types of transactions enabled by the electronic pricing facility).

In some examples, the protected price 300 is enabled for some types of fuel but not others. For example, the protected price 300 may be enabled for gasoline, and not enabled for diesel fuel. In this way, a consumer would pay the protected price 300 for gasoline, and a conventional retail price for diesel (or vice-versa, depending on the types of transactions enabled by the electronic pricing facility).

As another real-world example, a commercial entity 112 could be a grocery retailer or a consumer goods company (e.g., food manufacturer) operating in association with the grocery retailer. The commercial entity 122a could be a gasoline provider. The purchase tool 126 could be a gasoline card that is “loaded” with scrip based on funding from the grocery retailer or consumer goods company. A consumer earns scrip by purchase of goods 110, e.g., a specific product, a specific group of products, or total spending at the grocery retailer.

A grocery store advertises “pay 89 cents per litre of fuel” with a maximum number of litres. The ceiling price (e.g., promotional price plus ceiling discount value) can be set to $1.49 per litre. Thus, each litre costs $0.60 per litre to the grocery store (or to any entity who pays for the costs of the promotion, such as a producer of consumer goods). When the transactions are completed, the cost to the grocery store may be expected to be lower (i.e. fuel prices are $1.29/L and settlement is $0.40 per litre). For example, the ceiling discount value is in place as a buffer between current actual prices (or fairly current) to compensate for the possibility that prices may have a sudden jump based on market conditions. The likelihood is that when the card is used there will be a delta between the ceiling and the actual. For example, the ceiling price may be $1.49 and the actual price may be $1.29 when the card is used. This would result in a $0.20 difference, e.g., profit for the electronic pricing facility, and/or a possible credit back to the grocery store (or any entity who pays for the costs of the promotion).

The grocery store advertises three possible ways to earn:

List of products which add to the earned litres

1. 1 L—4 L milk

### 2. 2 L—Cereal

### 3. 5 L—Razor

### 4. 3 L—Peanut Butter

Bundle

1. 10 L—Razor and Shaving Cream (produced by the consumer goods company)
2. 7 L—Detergent and Fabric Softener (produced by the consumer goods company)
3. 10 L—Diapers and Cough Syrup (produced by the consumer goods company)

Total Spending

1. 2 L—When you spend $50 or more
2. 5 L—When you spend $75 or more
3. 10 L—When you spend $100 or more
4. 2 L—When you spend $175 or more

For the three above ways to earn, different parties can pay for the incentive

Product Specific—Can be paid by the consumer goods company to promote a product.

Bundle—Can be paid by consumer goods company to promote products in the same umbrella.

Total Spend—Can be paid by the grocery retailer to grow total basket size.

In the above example, the consumer goods company may sponsor specific products in flyers with a discount. This would be a transfer of discount to litres at a specific price which equates to a value (or cost to CPG/Sobeys) to the customer. If a customer purchases multiple products they can be awarded with enough litres to fill a tank at the lower price. Gas and grocery purchases tend to be weekly transactions; this is a way in which grocery stores can convert product discounting to earning fuel savings.

The promotional value (scrip) loaded onto the card could have an expiry date timeframe, e.g., two weeks from time of load. The card could enable a single fill-up or the card may be valid until litres are depleted.

The consumer may be able to keep the card and the card can be re-loaded on a future purchase.

The electronic pricing facility 100 could administer a “loyalty card” system in which customers of the grocery store or purchasers of particular goods can use a loyalty card to track purchases and earn scrip that can be applied to fuel. For example, a consumer can register a fuel card with the grocery store, and the electronic pricing facility 100 will provide a real-time load of scrip to the fuel card immediately after the grocery store purchase.

For example, a consumer can undergo the following process:

1. Get a grocery store loyalty card—e.g., when this is swiped at time of purchase the electronic pricing facility 100 receives transactional information in real-time.
2. Get a gasoline card and link to the grocery store card—e.g., visit a website to link your card or link the card with the grocery store loyalty card at the register
3. Make eligible purchases at a grocery store, swipe grocery store loyalty card
4. The electronic pricing facility 100 loads the gasoline card with the eligible promotion in real-time—e.g., $0.89 per litre×eligible litres
5. A text message (or e-mail) can be sent to the customer with litres loaded and expiry date of the litres

Customer fuels up and uses the gasoline card as a payment device to receive the gasoline at a protected price.

As another real-world example, the electronic pricing facility 100 could enable employee incentives with a reload function for company recruiting and retention. For example, a company could use the electronic pricing facility 100 to maintain a constant or reduced price of fuel, e.g., for companies that require employees to use a personal vehicle, for any sub-contracted vehicle operator (such as a taxi driver), etc. Employers can reload allotted litres on a periodic basis. For example, a company can load 100 litres per month to fix fuel at $1.25 per litre with minimum savings (floor discount value) of $0.10 per litre and maximum savings (ceiling discount value) of $0.50 per litre. This enables a company's employee to fill up to $1.75 per litre (to pay $1.25) with a minimum savings of $0.10 on a monthly maximum of 100 litres. In this example, the company would have a capped cost of $50 per month with a minimum cost of $10 per month. In this example, the unused litres may expire on a monthly basis, since the employer is paying for the incentive.

As another real-world example, casinos can buy gasoline cards to incentivize guests to drive to the casino. The gasoline can have a set price of $0.99/L to a maximum of 75 L with a ceiling of $1.49/L which is a $0.50/L ceiling discount value. An advance payment in this example would be 75 L×$0.50 or $37.50. Once a guest fills their tank (perhaps one time) the actual total discounted price difference can be determined, e.g., $20 depending on fuel prices at the time of the fill. Since gasoline is a weekly purchase for most, this incentive is designed to promote loyalty at the casino via weekly visits.

In some implementations, a hedging strategy could be used by the host 103 of the electronic pricing facility 100. In an example promotion of fuel (e.g., gasoline), a promotional price, number of litres of fuel and an expiration date can determined, e.g., $0.99 per litre of fuel for 1,000 litres valid for six months. The promotion can be offered by a commercial entity, which we here call a promoter, and the time in which the promotion is valid is sometimes called a promotional time-frame.

In this example, the current retail price of fuel may be $1.29 per litre which results in a current cost of $0.30 per litre if fuel prices do not fluctuate at all in the next six months. Further, prices are likely to fluctuate, so the host 103 may quote a cost to the promoter higher than current prices. The difference in the current cost and the quoted cost is referred to as a premium or a risk premium. The host 103 can choose the premium based on various factors, including the promotional price and the expiration date. Since the promotional price is lower than the current price, the host 103 may charge a $0.20 per litre premium.

In this example, the cost to the promoter would be (1,000 litres×$0.30)=$300 (cost of the promotion)+(1,000 L×$0.20)=$200 (risk premium) for a total of $500.

The $300 cost of the promotion would be set aside by the host 103 to cover expected fuel costs, e.g., should prices stay the same over six months. The remaining $200 would be used by the host 103 to hedge the risk.

The risk can be outsourced to another party such as an insurance company or investment bank. For example, some or all of the $200 can be placed into the commodities market, betting on fuel prices rising. For example, the host 103 could buy options contracts in United States Oil Fund (stock quote USO) which invests in world oil futures contracts. The retail price of fuel (e.g., purchased at gas stations) depends on multiple factors, for example, crude oil costs and taxes. For example, the retail price of fuel may go up when world crude oil costs rise. Accordingly, USO may have a strong correlation to the retail price of fuel.

As litres get used during the promotional time-frame the host 103 would gradually sell the positions in the investments to recover the risk premium, converting it into cash reserves.

Three things can happen during the promotional time-frame:

a) Pump prices go down on average—e.g., the invested premium loses money in the markets, which is offset by the expected fuel costs are lower.

b) Pump prices stay the same on average—e.g., the invested premium loses money in the markets, but the expected fuel costs cover the usage.

Pump prices go higher on average—e.g., the invested premium gains money in the markets (higher fuel prices means USO increased in value) and the expected fuel costs will be higher than anticipated. In this example the premium should grow in the financial markets to cover the additional costs incurred by the higher fuel costs for a positive cash flow.

FIG. 4 is a block diagram of an example computer system 400. For example, referring to FIG. 1, the electronic pricing facility 100 or a server forming a portion of the electronic pricing facility 100 could be an example of the system 400 described here, as could a computer system used by any of users who access resources of the electronic pricing facility 100 (e.g., a user associated with the host 103 who configures operations of the electronic pricing facility 100). The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In some implementations, the processor 410 is a multi-threaded processor. In some implementations, the processor 410 is a quantum computer. The processor 410 is capable of processing instructions stored in the memory 420 or on the storage device 430.

The memory 420 stores information within the system 400. In some implementations, the memory 420 is a computer-readable medium. In some implementations, the memory 420 is a volatile memory unit. In some implementations, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, a solid-date drive, a flash drive, magnetic tape, or some other large capacity storage device. The input/output device 440 provides input/output operations for the system 400. In some implementations, the input/output device 440 can include one or more of a network interface devices, e.g., an Ethernet card, a serial communication device, e.g., an RS-232 port, and/or a wireless interface device, e.g., an 802.3 card, a 3G wireless modem, a 4G wireless modem, or a carrier pigeon interface. In some implementations, the input/output device can include driver devices configured to receive input data and send output data to other input/output devices, e.g., keyboard, printer and display devices 460. In some implementations, mobile computing devices, mobile communication devices, and other devices can be used. A server (e.g., a server forming a portion of the electronic pricing facility 100 shown in FIG. 1) can be realized by instructions that upon execution cause one or more processing devices to carry out processes relevant to the functions described above. Such instructions can comprise, for example, interpreted instructions such as script instructions, or executable code, or other instructions stored in a computer readable medium. A server can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

Although example devices have been described in FIG. 3, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a processing system. The computer readable medium can be a physical device such as a machine readable storage device, a machine readable storage substrate, a memory device, a composition of matter effecting a machine readable propagated signal, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. Sometimes a server is a general purpose computer, and sometimes it is a custom-tailored special purpose electronic device, and sometimes it is a combination of these things.

Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Certain features that are described above in the context of separate implementations can also be implemented in combination in a single implementation. Conversely, features that are described in the context of a single implementation can be implemented in multiple implementations separately or in any sub-combinations.

The order in which operations are performed as described above can be altered. In certain circumstances, multitasking and parallel processing may be advantageous. The separation of system components in the implementations described above should not be understood as requiring such separation.

Other implementations are within the scope of the following claims.

1. A computer-implemented method comprising:
enabling, by an electronic pricing facility, purchases of a commodity at a protected price that represents a discount from a current price of the commodity that increases as the current price rises above a middle range of the current price.

2. The method of claim 1 in which the discount from the current price of the commodity decreases as the current price drops below the middle range of the current price.

3. The method of claim 1 in which the protected price comprises a static promotional price that applies in the middle range of the current price.

4. The method of claim 1 in which the middle range comprises a static upper current price.

5. The method of claim 1 in which the middle range comprises a static lower current price.

6. The method of claim 1 in which the protected price comprises a maximum amount of discount from the current price of the commodity.

7. The method of claim 1 in which the commodity is available for purchase at the protected price from only a single supplier.

8. The method of claim 1 in which the commodity is available for purchase at the protected price from multiple suppliers.

9. The method of claim 1 in which the discount represented by the protected price is defined in a promotion of a commercial entity.

10. The method of claim 1 in which at least part of the discount is paid by an entity other than the electronic pricing facility.

11. The method of claim 1 in which each of the purchases comprises a protected price determined based on a promotional price and a ceiling discount value representing a maximum discount from the current price of the commodity, in which the protected price is less than the current price of the commodity.

12. The method of claim 11, in which the purchase comprises a floor discount value representing a minimum discount from the current price of the commodity.

13. The method of claim 11 in which the difference between the protected price and the current price is paid in advance, by an entity other than the electronic pricing facility, based on the ceiling discount value.

14. The method of claim 13 in which any amount of the difference that remains after the purchases is not refunded to the entity.

15. The method of claim 1 in which each of the purchases is enabled depending on an expiration date associated with the discount.

16. The method of claim 1 in which each of the purchases is enabled depending on a remaining quantity of the commodity, the remaining quantity associated with the discount.

17. The method of claim 1 comprising receiving an advance payment of the discount.

18. The method of claim 17 in which at least a portion of the advance payment of the discount is invested according to a hedging strategy.

19. A computer-implemented method comprising:
receiving first data representing a transaction for a quantity of a commodity;
receiving second data associated with a person associated with the transaction, the second data representing a promotional price and a ceiling discount value representing a maximum discount from a current price of the commodity;
calculating a protected price based on the promotional price and the ceiling discount value, in which the protected price is equal to the promotional price for a first range of the current price of the commodity, and equal to the current price of the commodity minus the ceiling discount value for a second range of the current price of the commodity;
transmitting data authorizing the transaction at the protected price; and
updating the second data based on the data describing the transaction.

20. A method comprising:
enabling, at a fuel station, a purchase of a quantity of fuel, the purchase comprising a discount from a current retail price of fuel, the discount determined based on a promotional price and a ceiling discount value representing a maximum discount from the current retail price.
